(19) United States
(12) Patent Application Publication
(10) Pub. No.: US 2025/0102966 A1
(43) Pub. Date: Mar. 27, 2025

(54) TRANSFER DEVICE AND IMAGE FORMING APPARATUS

(71) Applicant: FUJIFILM Business Innovation Corp., Tokyo (JP)

(72) Inventor: Ko UMENAI, Kanagawa (JP)

(73) Assignee: FUJIFILM Business Innovation Corp., Tokyo (JP)

(21) Appl. No.: 18/442,121

(22) Filed: Feb. 15, 2024

(30) Foreign Application Priority Data
Sep. 26, 2023 (JP) 2023-163180

(51) Int. Cl. G03G 15/16

(52) U.S. Cl. CPC G03G 15/1605; G03G 2215/1623

(57) ABSTRACT

A transfer device includes: a transfer member that is formed in an endless band-like shape and to which a toner image is transferred; a transfer cylinder that includes a cylinder body having an outer peripheral surface at which a recess portion extending in an axial direction is formed and a transfer jacket that is wound around the outer peripheral surface such that both end portions of the transfer jacket are disposed outside the recess portion; and a transfer roll that extends in the axial direction, that transfers the toner image to a recording medium wound around the transfer cylinder while sandwiching the transfer member together with the transfer jacket, and that repeats collision and separation with respect to the transfer jacket as the transfer roll passes through the recess portion, in which at least one end portion out of both end portions of the transfer jacket includes an edge that is not parallel to an axis of the transfer roll.

### CROSS-REFERENCE TO RELATED APPLICATIONS

This application is based on and claims priority under 35 USC 119 from Japanese Patent Application No. 2023-163180 filed Sep. 26, 2023.

### BACKGROUND

### (i) Technical Field

The present invention relates to a transfer device and an image forming apparatus.

### (ii) Related Art

Disclosed in JP2023-59720A is an image forming apparatus including a transfer cylinder, in which the transfer cylinder is provided with a tapered surface.

### SUMMARY

Regarding an image forming apparatus including a transfer device, in the case of a configuration in which collision and separation between a transfer roll and a transfer jacket of a transfer cylinder are repeated as the transfer roll passes through a recess portion of the transfer cylinder, a load fluctuation with respect to a transfer member sandwiched by the transfer roll and the transfer jacket occurs in the case of collision or separation between the transfer jacket and the transfer roll.

Aspects of non-limiting embodiments of the present disclosure relate to a transfer device and an image forming apparatus that suppress a load fluctuation of a transfer member in comparison with a configuration in which both end portions of a transfer jacket are parallel with an axis of a transfer roll.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a transfer device including a transfer member that is formed in an endless band-like shape and to which a toner image is transferred; a transfer cylinder that includes a cylinder body having an outer peripheral surface at which a recess portion extending in an axial direction is formed and a transfer jacket that is wound around the outer peripheral surface such that both end portions of the transfer jacket are disposed outside the recess portion; and a transfer roll that extends in the axial direction, that transfers the toner image to a recording medium wound around the transfer cylinder while sandwiching the transfer member together with the transfer jacket, and that repeats collision and separation with respect to the transfer jacket as the transfer roll passes through the recess portion, in which at least one end portion out of both end portions of the transfer jacket includes an edge that is not parallel to an axis of the transfer roll.

### BRIEF DESCRIPTION OF THE DRAWINGS

Exemplary embodiment(s) of the present invention will be described in detail based on the following figures, wherein:

FIG. 1 is a schematic view showing an image forming apparatus according to an exemplary embodiment of the present disclosure;

FIG. 2 is a perspective view showing a configuration around a transfer cylinder according to the exemplary embodiment of the present disclosure;

FIG. 3 is a perspective view showing a gripper according to the exemplary embodiment of the present disclosure;

FIG. 4 is a schematic view showing a positional relationship between the transfer cylinder and a secondary transfer roll according to the exemplary embodiment of the present disclosure;

FIG. 5 is a schematic view showing a state where the secondary transfer roll rides on an upstream end of a recess portion of the transfer cylinder according to the exemplary embodiment of the present disclosure;

FIG. 6 is a schematic view showing a state where the transfer roll is released from a downstream end of the recess portion of the transfer cylinder according to the exemplary embodiment of the present disclosure;

FIG. 7 is a perspective view showing a configuration around a transfer cylinder according to another exemplary embodiment of the present disclosure; and

A part (a) in FIG. 8 is a schematic top view showing a first example of the vicinity of an upstream end of a transfer jacket according to the exemplary embodiment of the present disclosure, a part (b) in FIG. 8 is a schematic top view showing a second example thereof, a part (c) in FIG. 8 is a schematic top view showing a third example thereof, and a part (d) in FIG. 8 is a schematic top view showing a fourth example thereof.

### DETAILED DESCRIPTION

An example of an exemplary embodiment according to the exemplary embodiment of the invention will be described below with reference to the drawings.

### Image Forming Apparatus 10

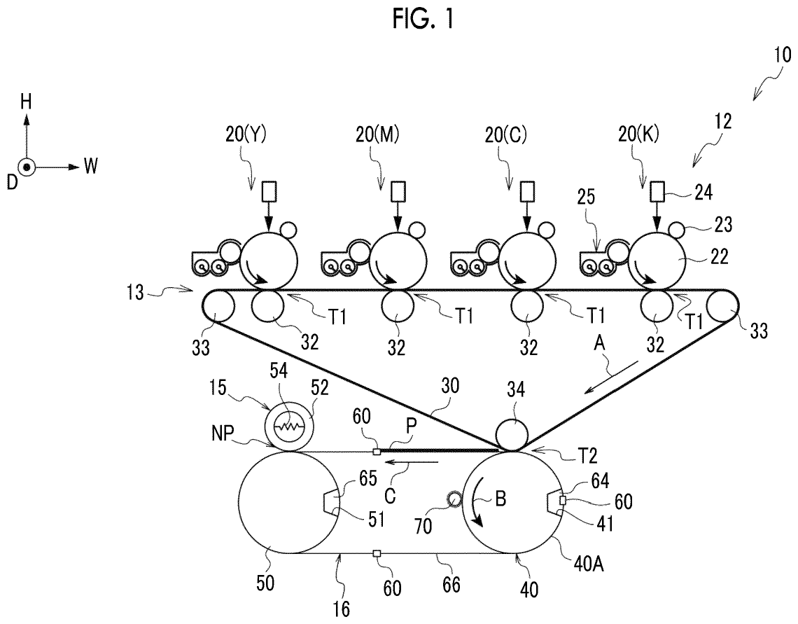

The configuration of an image forming apparatus 10 according to an exemplary embodiment (hereinafter, will be referred to as “the present exemplary embodiment”) of the present disclosure will be described. FIG. 1 is a schematic view showing the configuration of the image forming apparatus 10 according to the present exemplary embodiment. An arrow H shown in each drawing indicates a vertical direction that is an apparatus up-down direction, an arrow W indicates a horizontal direction that is an apparatus width direction, and an arrow D indicates a horizontal direction that is an apparatus depth direction (an apparatus front-rear direction). The apparatus depth direction is an example of an axial direction. Dimensional ratios between parts shown in the respective drawings in an H direction, a W direction, and a D direction may differ from actual dimensional ratios.

The image forming apparatus 10 shown in FIG. 1 is an image forming apparatus that forms a toner image (an example of an image) on a recording medium P. Specifically, the image forming apparatus 10 includes an image forming unit 12, a fixing device 15, and a transport mechanism 16. Hereinafter, each part (the image forming unit 12, the fixing device 15, and the transport mechanism 16) of the image forming apparatus 10 will be described.

### Image Forming Unit 12

The image forming unit 12 is a constituent unit that forms a toner image on the recording medium P through an electrophotographic method. Specifically, as shown in FIG. 1, the image forming unit 12 includes toner image forming units 20 that form toner images and a transfer device 13 that transfers, to the recording medium P, the toner images formed by the toner image forming unit 20.

### Toner Image Forming Unit 20

A plurality of the toner image forming units 20 as shown in FIG. 1 are provided to form toner images of respective colors. In the present exemplary embodiment, the toner image forming units 20 for a total of four colors which are yellow (Y), magenta (M), cyan (C), and black (K) are provided. (Y), (M), (C), and (K) shown in FIG. 1 indicate constituent parts corresponding to the respective colors.

Note that the toner image forming units 20 for the respective colors have the same configuration as each other except for a toner to be used. Therefore, in FIG. 1, each part of a toner image forming unit 20 (K), which serves as a representative of the toner image forming units 20 for the respective colors, is shown with a reference numeral given thereto.

Specifically, each of the toner image forming units 20 for the respective colors includes a photoreceptor 22 that rotates in one direction (for example, a counterclockwise direction in FIG. 1). In addition, each of the toner image forming units 20 for the respective colors includes a charger 23, an exposure device 24, and a developing device 25.

In each of the toner image forming units 20 for the respective colors, the charger 23 charges the photoreceptor 22. Furthermore, the exposure device 24 causes the photoreceptor 22 charged by the charger 23 to light so that an electrostatic latent image is formed on the photoreceptor 22. In addition, the developing device 25 develops the electrostatic latent image, which is formed on the photoreceptor 22 by the exposure device 24, to form a toner image.

### Transfer Device 13

The transfer device 13 shown in FIG. 1 is a device that transfers, to the recording medium P, toner images formed by the toner image forming units 20. Specifically, the transfer device 13 primarily transfers, to a transfer belt 30, toner images on the photoreceptors 22 for the respective colors such that the toner images are superimposed on each other and secondarily transfers, to the recording medium P, the superimposed toner images. The transfer belt 30 is an example of a transfer member. As shown in FIG. 1, the transfer device 13 includes the transfer belt 30, primary transfer rolls 32, and a transfer cylinder 40.

The primary transfer rolls 32 are rolls that transfer, to the transfer belt 30, the toner images on the photoreceptors 22 for the respective colors at primary transfer positions T1 between the photoreceptors 22 and the primary transfer rolls 32. In the present exemplary embodiment, a primary transfer electric field is applied between the primary transfer rolls 32 and the photoreceptors 22, so that the toner images formed on the photoreceptors 22 are transferred to the transfer belt 30 at the primary transfer positions T1.

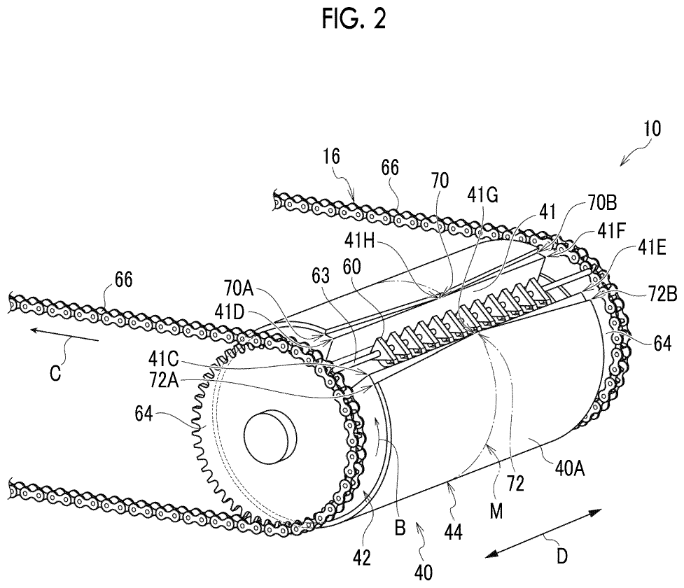

The toner images are transferred to an outer peripheral surface of the transfer belt 30 from the photoreceptors 22 for the respective colors. As shown in FIG. 1, the transfer belt 30 has an endless shape (a band-like shape in FIG. 2) and is wound around a plurality of rolls 33 and a secondary transfer roll 34 (which will be described later) such that the transfer belt 30 has an inverted triangular shape as seen in a front view (as seen in the apparatus depth direction). The transfer belt 30 revolves in a direction along an arrow A as at least one of the plurality of rolls 33 is rotationally driven. That is, the transfer belt 30 is driven to rotate and the toner images are transferred.

The secondary transfer roll 34 has a cylindrical shape extending in a depth direction. The secondary transfer roll 34 is an example of a transfer roll. The secondary transfer roll 34 sandwiches the transfer belt 30 together with d a transfer jacket 44 which will be described later and transfers the toner images to the recording medium P wound around the transfer cylinder 40 which will be described later. More specifically, the secondary transfer roll 34 sandwiches the transfer belt 30 together with the transfer jacket 44 with the secondary transfer roll 34 biting into the transfer jacket 44. The secondary transfer roll 34 rotates in a state of pressing a back surface of the transfer belt 30 which is opposite to one surface onto which the toner images are transferred.

As shown in FIGS. 1 and 2, a recess portion 41 is formed at an outer peripheral surface 40A of the transfer cylinder 40 and the transfer cylinder 40 rotates in a rotation direction B. The recess portion 41 extends in an axial direction (the depth direction) of the transfer cylinder 40 and has a depth along a radial direction of the transfer cylinder 40. Note that side end portions of the recess portion 41 in the depth direction are end portions 41C, 41D, 41E, and 41F, respectively and a shape obtained by connecting the four end portions is a rectangular shape in a top view.

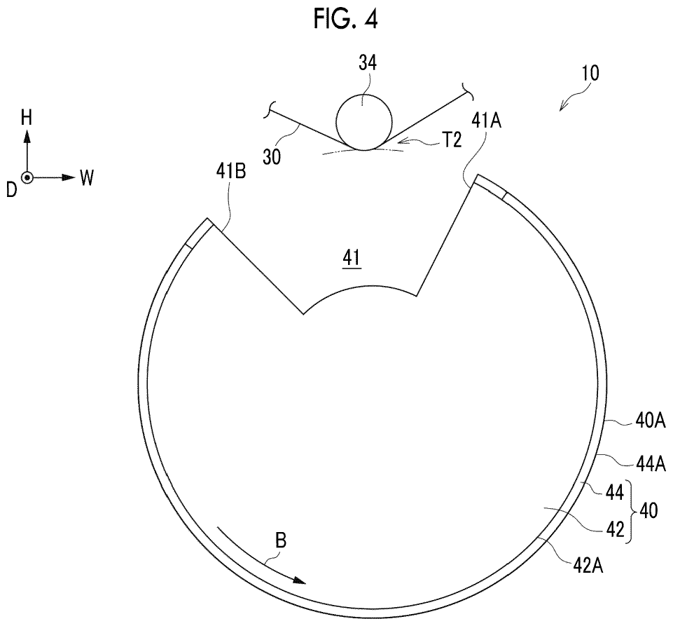

As shown in FIG. 1, the transfer cylinder 40 is disposed below the transfer belt 30 such that the transfer cylinder 40 faces the transfer belt 30. Furthermore, the transfer cylinder 40 comes into contact with the transfer belt 30 in a range on the outer peripheral surface 40A from an upstream end 41A to a downstream end 41B in a rotation direction of the recess portion 41 (refer to FIG. 4). Specifically, the upstream end 41A and the downstream end 41B are opening-side end portions of the recess portion 41 (that is, end portions on a radially outer side of the transfer cylinder 40).

Specifically, as shown in FIG. 4, the transfer cylinder 40 includes a cylinder body 42 and the transfer jacket 44. The transfer cylinder 40 is disposed close to the one surface of the transfer belt 30 to which the toner images are transferred.

The recess portion 41 is formed at a cylindrical surface 42A which is an outer peripheral surface of the cylinder body 42. Specifically, as shown in FIG. 2, the cylinder body 42 has a cylindrical shape extending in the depth direction and the recess portion 41 extending in the depth direction is formed at the cylindrical surface 42A. The recess portion 41 accommodates grippers 60 and an attachment member 63 in the transport mechanism 16 which will be described later. In addition, the cylinder body 42 is formed of a metal material such as stainless steel and aluminum, for example.

As shown in FIG. 4, the transfer jacket 44 has a shape like a sheet that is wound around the cylindrical surface 42A of the cylinder body 42 over a range from the upstream end 41A to the downstream end 41B in the rotation direction of the recess portion 41. That is, the transfer jacket 44 is wound around the cylindrical surface 42A such that both end portions of the transfer jacket 44 are disposed outside the recess portion 41. The outer peripheral surface 40A of the transfer cylinder 40 is formed by an outer peripheral surface 44A of the transfer jacket 44. The outer peripheral surface 44A of the transfer jacket 44 and the secondary transfer roll 34 which will be described later sandwich the transfer belt 30 and the recording medium P. In such a state, the secondary transfer roll 34 bites into the transfer jacket 44. As the transfer jacket 44, for example, foamed rubber including an elastic layer and a surface layer is used. In the present exemplary embodiment, the transfer jacket 44 is attached to the cylinder body 42 such that the transfer jacket 44 can be replaced. More specifically, in a state of being wound around the cylindrical surface 42A of the cylinder body 42, the transfer jacket 44 includes a base layer, an elastic layer, and a surface layer (which are not shown) in order of increasing distance to the cylindrical surface 42A and has a determined thickness. A jig for attachment and detachment (not shown) is provided at an end portion of the base layer (not shown) of the transfer jacket 44 and the transfer jacket 44 is attached to the cylinder body 42 via the jig for attachment and detachment. Regarding the transfer cylinder 40, collision and separation between the secondary transfer roll 34 and the transfer jacket 44 are repeated as the secondary transfer roll 34 passes through the recess portion 41. More specifically, the secondary transfer roll 34 is separated from one end portion 70 of the transfer jacket 44 in a case where the secondary transfer roll 34 enters a space above the recess portion 41 from the downstream end 41B side and the secondary transfer roll 34 collides with the other end portion 72 of the transfer jacket 44 in a case where the secondary transfer roll 34 exits the recess portion 41 via the upstream end 41A (refer to FIG. 2). After the collision, the outer peripheral surface 44A of the transfer jacket 44 of the transfer cylinder 40 and the secondary transfer roll 34 (which will be described later) sandwich the transfer belt 30 and the recording medium P.

As shown in FIGS. 2 and 4, each of the one end portion 70 and the other end portion 72 of the transfer jacket 44 is formed in a triangular shape, the one end portion 70 being on the downstream end 41B side in the rotation direction of the recess portion 41 of the cylinder body 42 and the other end portion 72 being on the upstream end 41A side. Hereinafter, description about the one end portion 70 and the other end portion 72 of the transfer jacket 44 is description about the above-described elastic layer and surface layer unless otherwise specified. The one end portion 70 and the other end portion 72 are examples of end portions of a transfer jacket. Each of the positions of the one end portion 70 and the other end portion 72 of the transfer jacket 44 in a circumferential direction of a cylinder body (the positions of side end portions 70A and 70B and side end portions 72A and 72B (which will be described later) in the circumferential direction) is determined based on an image formation region on the recording medium P (refer to part (a) in FIG. 8). Specifically, portions of the transfer jacket 44 that are positioned radially inside a margin portion of the recording medium P wound around the transfer cylinder 40 or part thereof are the one end portion 70 and the other end portion 72, the margin portion being a portion of the recording medium P on which no image is formed. In addition, as shown in FIG. 2, both side ends of the transfer jacket 44 in the depth direction (the positions of the side end portions 70A and 70B and the side end portions 72A and 72B (which will be described later) in the depth direction) are along the circumferential direction of the cylinder body 42. For the sake of convenience, the following description will be made on an assumption that a virtual reference line M is present at the center of a space between the both side ends in the depth direction.

Since a surface that extends toward the reference line M from the side end portion 70A on a front side in the depth direction and a surface that extends toward the reference line M from the side end portion 70B on a rear side in the depth direction are formed, the one end portion 70 of the transfer jacket 44 has a triangular shape, of which the vertex angle is on the recess portion 41 side, on the downstream end 41B side in the rotation direction of the recess portion 41 (refer to part (a) in FIG. 8). Since a surface that extends toward the reference line M from the side end portion 72A on the front side in the depth direction and a surface that extends toward the reference line M from the side end portion 72B on the rear side in the depth direction are formed, the other end portion 72 of the transfer jacket 44 has a triangular shape, of which the vertex angle is on the recess portion 41 side, on the upstream end 41A side in the rotation direction of the recess portion 41. In the present exemplary embodiment, each of the shapes of the one end portion 70 and the other end portion 72 of the transfer jacket 44 is an isosceles triangular shape. That is, the transfer jacket 44 has a hexagonal shape in an unfolded state.

Accordingly, the one end portion 70 and the other end portion 72 of the transfer jacket 44 extend in a direction intersecting the depth direction (a direction along an axis of the secondary transfer roll 34) and each of the one end portion 70 and the other end portion 72 includes edges that are not parallel with the axis of the secondary transfer roll 34 and are on the recess portion 41 side. In the present exemplary embodiment, since each of the one end portion 70 and the other end portion 72 has an isosceles triangular shape, directions in which the edges of the one end portion 70 and the other end portion 72 extend are directions intersecting the axis of the secondary transfer roll 34 and are not parallel with each other. In addition, as shown in FIGS. 2 and 8A, it can be said that the length of a side (a base) L, which extends along the depth direction, of a triangular portion of each of the one end portion 70 and the other end portion 72 of the transfer jacket 44 gradually decreases toward the recess portion 41. Note that the length of the base L becomes longest at a line segment connecting the side end portion 70A and the side end portion 70B to each other. Furthermore, the length (the length of each of the feet of perpendicular lines from the side end portions 70A, 70B, 72A, and 72B to the reference line M) of a side, which extends toward the reference line M along the depth direction, of the triangular portion of each of the one end portion 70 and the other end portion 72 of the transfer jacket 44 gradually decreases toward the recess portion 41.

The one end portion 70 and the other end portion 72 of the transfer jacket 44 face each other with the recess portion 41 interposed therebetween in a state where the transfer jacket 44 is wound around the cylinder body 42 and the shapes of the one end portion 70 and the other end portion 72 are triangular shapes that are the same as each other. The reference line M is a line extending through a center 41H of the downstream end 41B of the recess portion 41 in the depth direction and a center 41G of the upstream end 41A in the depth direction. Therefore, the one end portion 70 and the other end portion 72 are formed to be symmetric in the depth direction with respect to the reference line M. That is, the entire transfer jacket 44 is formed to be symmetric in the depth direction with respect to the reference line M.

In a state where the transfer jacket 44 is wound around the cylindrical surface 42A (the outer peripheral surface) of the cylinder body 42, regions (hereinafter, may be referred to as “regions in which the base layer of the transfer jacket 44 is exposed”) in which the transfer jacket 44 is not wound around the cylinder body are formed on the cylinder body 42 on each of the upstream end 41A side and the downstream end 41B side of the recess portion 41. Each of the regions has a shape corresponding to the one end portion 70 and the other end portion 72 of the transfer jacket 44. In the present exemplary embodiment, the regions are four right-angled triangles of which the hypotenuses are the one end portion 70 or the other end portion 72 of the transfer jacket 44.

In addition, as shown in FIG. 2, a pair of sprockets 64 is provided on both of axial end sides of the transfer cylinder 40. The pair of sprockets 64 is disposed to be coaxial with the transfer cylinder 40. In addition, the transfer cylinder 40 rotates integrally with the pair of sprockets 64 in the rotation direction B as the cylinder body 42 rotates in the rotation direction B by being rotationally driven by a drive unit (not shown).

In the present exemplary embodiment, the transfer belt 30 and the transfer cylinder 40 transport the recording medium P in a state where the recording medium P is sandwiched between the transfer belt 30 and the transfer cylinder 40 at a secondary transfer position T2 (refer to FIG. 1). Then, a secondary transfer electric field is applied between the secondary transfer roll 34 and the transfer cylinder 40, so that the toner images transferred onto the transfer belt 30 are transferred to the recording medium P at the secondary transfer position T2. Note that in a case where the grippers 60 (which will be described later) holding the recording medium P and the attachment member 63 pass through the secondary transfer position T2, the grippers 60 and the attachment member 63 are accommodated in the recess portion 41 and thus contact between the grippers 60, the attachment member 63, and the transfer belt 30 does not occur.

### Fixing Device 15

In the present exemplary embodiment, the fixing device 15 is a device that fixes, onto the recording medium P, the toner images that are transferred onto the recording medium P via the transfer cylinder 40. Specifically, as shown in FIG. 1, the fixing device 15 includes a fixation cylinder 50 and a heating roll 52.

In the fixing device 15, the heating roll 52 is disposed above the fixation cylinder 50. The heating roll 52 includes a heating source 54 such as a halogen lamp inside the roll.

A recess portion 51 is provided at an outer peripheral surface of the fixation cylinder 50. The recess portion 51 is provided at a portion of the outer peripheral surface of the fixation cylinder 50 in a circumferential direction. Furthermore, the recess portion 51 is formed to be long in an axial direction of the fixation cylinder 50 and has a depth along a radial direction of the fixation cylinder 50. The recess portion 51 accommodates the grippers 60 and the attachment member 63 which will be described later. Accordingly, in a case where the grippers 60 and the attachment member 63 pass through a fixation position NP shown in FIG. 1, contact between the grippers 60, the attachment member 63, and the heating roll 52 does not occur.

A pair of sprockets 65 is provided on both of axial end sides of the fixation cylinder 50. The pair of sprockets 65 is disposed to be coaxial with the fixation cylinder 50 and is configured to rotate integrally with the fixation cylinder 50.

In addition, at the fixing device 15, the recording medium P is heated and pressed while the recording medium P is being transported in a state of being sandwiched between the heating roll 52 and the fixation cylinder 50 at the fixation position NP, so that the toner images transferred onto the recording medium P are fixed onto the recording medium P.

### Transport Mechanism 16

The transport mechanism 16 shown in FIG. 1 is a mechanism that transports the recording medium P. As shown in FIGS. 1 and 2, the transport mechanism 16 includes a pair of chains 66 and the grippers 60. Note that one of the paired chains 66 is shown in FIG. 1 and the chain 66 and the grippers 60 are shown in a simplified manner in FIG. 1.

As shown in FIG. 1, each of the paired chains 66 is formed in an annular shape. As shown in FIG. 2, the paired chains 66 are disposed at an interval in the depth direction (the D direction in the drawing). The paired chains 66 are respectively wound around the paired sprockets 64 which are provided on both of the axial end sides of the transfer cylinder 40 and the paired chains 66 are respectively wound around the paired sprockets 65 (refer to FIG. 1) which are provided on both of the axial end sides of the fixation cylinder 50. In addition, the chains 66 revolve in a revolution direction C (a direction along an arrow C) as the transfer cylinder 40 and the pair of sprockets 64 are integrally rotationally driven in the rotation direction B (a direction along an arrow B).

As shown in FIG. 2, the attachment members 63 to which the grippers 60 are attached are suspended between the paired chains 66 along the depth direction. A plurality of the attachment members 63 are fixed to the pair of chains 66 at predetermined intervals in the revolution direction C of the chains 66.

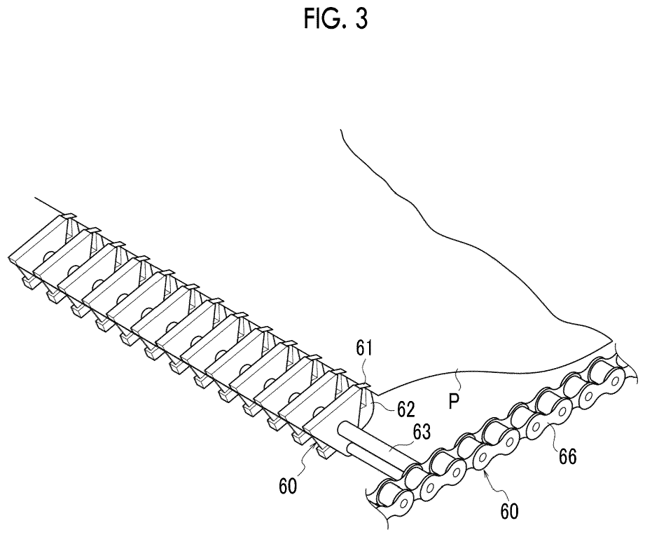

As shown in FIG. 2, a plurality of the grippers 60 are attached to each attachment member 63 at predetermined intervals in the depth direction. The grippers 60 hold a leading end portion of the recording medium P. Specifically, each gripper 60 includes a claw 61 and a claw base 62 as shown in FIG. 3. The gripper 60 is configured to hold the recording medium P with the leading end portion of the recording medium P being sandwiched between the claw 61 and the claw base 62. Note that, regarding the gripper 60, the claw 61 is pressed against the claw base 62 by a spring or the like and the claw 61 is opened or closed with respect to the claw base 62 by the action of a cam or the like.

In the transport mechanism 16, the leading end portion of the recording medium P fed from an accommodation portion (not shown) accommodating the recording medium P is held by the grippers 60 as shown in FIG. 3. With the chains 66 revolving in the revolution direction C, the grippers 60 holding the leading end portion of the recording medium P transports the recording medium P such that the recording medium P passes through the secondary transfer position T2 and the fixation position NP. Then, the toner images that are primarily transferred onto the transfer belt 30 at the primary transfer positions Tl for the respective colors to be superimposed onto each other are secondarily transferred onto the recording medium P at the secondary transfer position T2. The toner images secondarily transferred onto the recording medium P are fixed onto the recording medium P at the fixation position NP.

Note that the grippers 60 are accommodated into the recess portion 41, which is formed at the outer peripheral surface of the transfer cylinder 40, together with the attachment member 63 in a case where the grippers 60 pass through the secondary transfer position T2 and the grippers 60 are accommodated into the recess portion 51, which is formed at the outer peripheral surface of the fixation cylinder 50, together with the attachment member 63 in a case where the grippers 60 pass through the fixation position NP.

### Action and Effect of Present Exemplary Embodiment

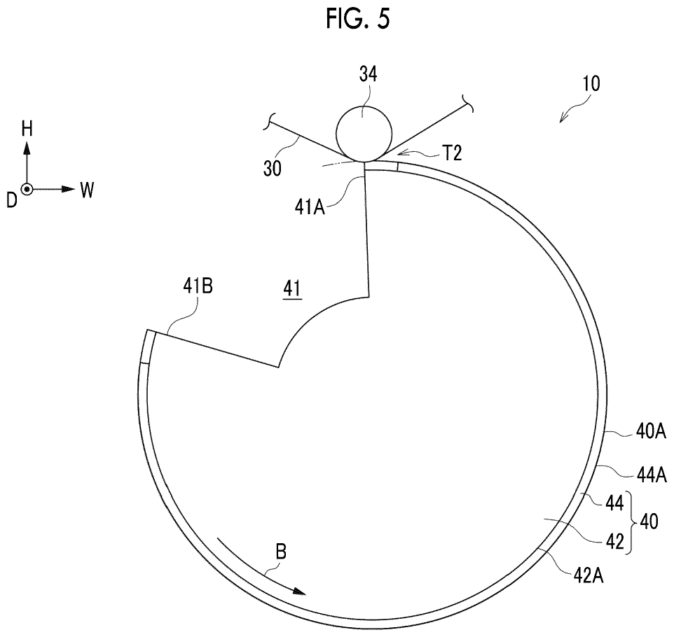

In the transfer device 13 of the present exemplary embodiment, as shown in FIG. 5, the secondary transfer roll 34 transfers toner images onto the recording medium P wound around the transfer cylinder 40 while repeating collision and separation with respect to the transfer jacket 44 of the transfer cylinder 40. In the image forming apparatus 10, the toner images transferred onto the recording medium P are fixed by the fixing device 15.

Here, in the transfer device 13, the secondary transfer roll 34 collides with the other end portion 72 of the transfer jacket 44 and sandwiches the transfer belt 30 and the recording medium P together with the transfer jacket 44 as the secondary transfer roll 34 withdraws from the recess portion 41.

As shown in FIGS. 2 and 5, in a case where the secondary transfer roll 34 collides with the other end portion 72 of the transfer jacket 44, the secondary transfer roll 34 collides with, first, a portion of the other end portion 72 that is closest to the upstream end 41A of the recess portion 41 and is on the reference line M. After colliding with such a portion, the secondary transfer roll 34 relatively rotates toward the one end portion 70 side of the transfer jacket 44, which rotates in a B direction together with the transfer cylinder 40, along the triangular shape of the other end portion 72 with the transfer belt 30 and the recording medium P sandwiched between the secondary transfer roll 34 and the transfer jacket 44 and transfers the toner images to the recording medium P. Since the length of contact between the outer peripheral surface 44A of the transfer jacket 44 and the transfer belt 30 and the recording medium P which are pressed by the secondary transfer roll 34 gradually increases at a triangular portion as the transfer cylinder 40 rotates in the B direction, a load from the transfer jacket 44 to the secondary transfer roll 34 gradually increases.

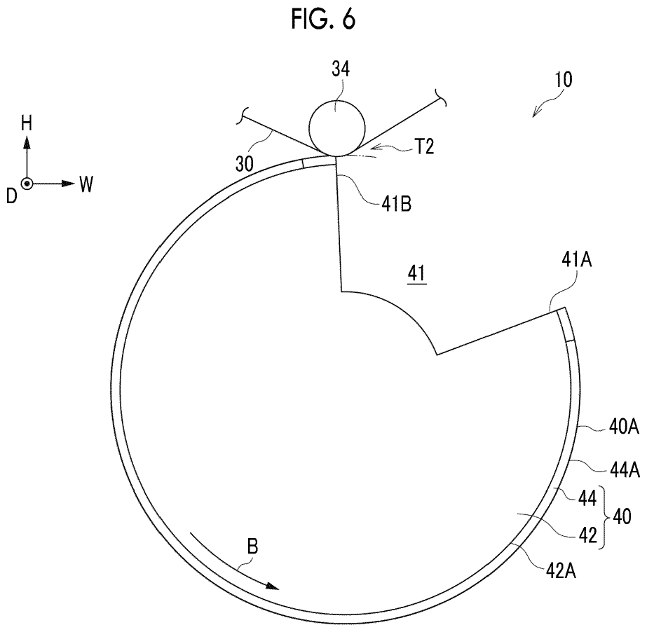

In addition, regarding the transfer device 13 of the present exemplary embodiment, the secondary transfer roll 34 enters a state as shown in FIG. 6 in a case where the transfer cylinder 40 in a state as shown in FIG. 5 rotates in the rotation direction B.

Specifically, with reference to FIGS. 2 and 6, in a state where the secondary transfer roll 34 presses the transfer belt 30 and the recording medium P against the transfer jacket 44, the transfer cylinder 40 rotates in the B direction to reach a position where the secondary transfer roll 34 presses the side end portions 70A and 70B of the transfer jacket 44. Since the one end portion 70 including the side end portions 70A and 70B is triangular, the length of contact with the outer peripheral surface 44A of the transfer jacket 44 decreases from such a position toward the downstream end 41B of the recess portion 41 as the transfer cylinder 40 rotates in the B direction. That is, the load from the transfer jacket 44 to the secondary transfer roll 34 gradually decreases. Thereafter, as the secondary transfer roll 34 passes through the recess portion 41, the secondary transfer roll 34 is separated from the transfer jacket 44 and the secondary transfer roll 34 is released from the downstream end 41B of the recess portion 41.

In the case of the transfer device 13 of the present exemplary embodiment, a load fluctuation of the transfer belt 30 is suppressed in comparison with a configuration in which both end portions (the one end portion 70 and the other end portion 72) of the transfer jacket 44 are parallel to the axis of the secondary transfer roll 34 (that is, a configuration in which collision or separation between the transfer jacket 44 and the secondary transfer roll 34 simultaneously occurs throughout the transfer jacket 44 in the axial direction).

In the transfer device 13 of the present exemplary embodiment, the transfer jacket 44 is symmetrical with respect to the reference line M as shown in FIG. 2, the secondary transfer roll 34 collides with, first, a portion of the other end portion 72 of the transfer jacket 44 that is on the reference line M, and the secondary transfer roll 34 is released from the recess portion 41 from a portion of the one end portion 70 that is on the reference line M. Therefore, in comparison with a configuration in which the transfer jacket is asymmetrical, diagonal movement of the transfer belt 30 in the axial direction that is caused by rotation of the transfer cylinder 40 is suppressed.

In the transfer device 13 of the present exemplary embodiment, the one end portion 70 or the other end portion 72 of the transfer jacket 44 extends to become closer to the reference line M from both side ends in the depth direction toward the recess portion 41. Therefore, processing of one end portion is easy in comparison with a configuration in which one end portion of the transfer jacket 44 extends toward a plurality of points.

In the transfer device 13 of the present exemplary embodiment, the one end portion 70 and the other end portion 72 of the transfer jacket 44 are not parallel to the axis of the secondary transfer roll 34. Therefore, a load fluctuation of the transfer belt 30 is suppressed for both of collision and separation between the secondary transfer roll 34 and the transfer jacket 44 in comparison with a configuration in which only one end portion is not parallel to the axis of the secondary transfer roll 34.

Since the transfer jacket 44 is attached to the cylinder body 42 such that the transfer device 13 may be replaced in the transfer device 13 of the present exemplary embodiment, the specifications of end portions (the one end portion 70 and the other end portion 72) of the transfer jacket 44 may be easily changed in comparison with a case where the transfer jacket 44 is fixed to the cylinder body 42.

In addition, the image forming apparatus 10 of the present exemplary embodiment includes the transfer device 13 of the present exemplary embodiment and thus distortion of an image formed on the recording medium P, which occurs because collision and separation between the secondary transfer roll 34 and the transfer jacket 44 are repeated as the secondary transfer roll 34 passes through the recess portion 41, is suppressed.

### Second Exemplary Embodiment

The configuration of the image forming apparatus 10 according to another exemplary embodiment (hereinafter, referred to as a “second exemplary embodiment”) of the present disclosure will be described. In the second exemplary embodiment, a basic configuration is the same as the configuration according to the present exemplary embodiment and description about the same configuration will be omitted.

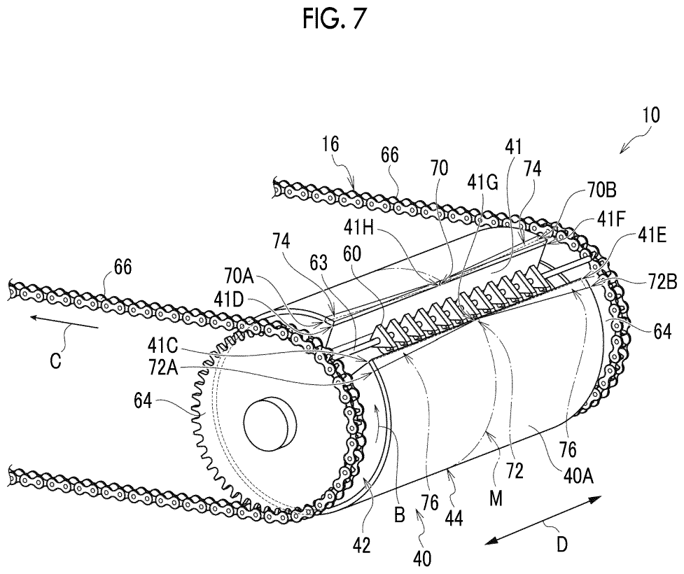

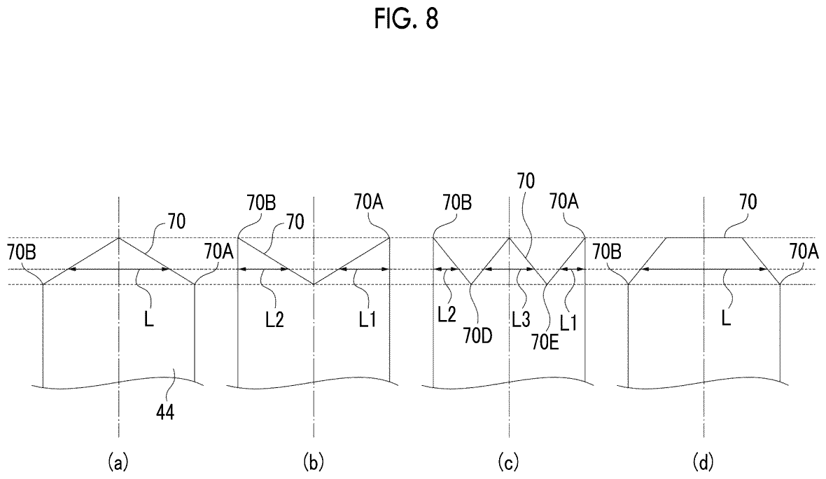

In the image forming apparatus 10 shown in FIG. 7, covers 74 and 76 are provided on regions where the base layer of the transfer jacket 44 of the present exemplary embodiment is exposed. Each of the covers 74 and 76 covers a portion between the recess portion 41 and the one end portion 70 or the other end portion 72 of the transfer jacket 44. The covers 74 and 76 are examples of a covering portion.

Each of the covers 74 and 76 is formed in a triangular shape and has an elastic modulus lower than the elastic modulus of the transfer jacket 44. In addition, the covers 74 and 76 have the same thickness as the transfer jacket 44 and each of the covers 74 and 76 may have a tapered shape. The covers 74 cover two regions between the one end portion 70 of the transfer jacket 44 and the downstream end 41B of the recess portion 41 where the base layer of the transfer jacket 44 is exposed. The covers 76 cover two exposed regions between the other end portion 72 of the transfer jacket 44 and the upstream end 41A of the recess portion 41. The covers 74 and the covers 76 have the same size and shape as each other.

### Action and Effect of Second Exemplary Embodiment

In the transfer device 13 of the second exemplary embodiment, in a case where the secondary transfer roll 34 collides with the other end portion 72, the secondary transfer roll 34 collides with a portion of the other end portion 72 that is closest to the upstream end 41A of the recess portion 41 and is on the reference line M and portions of the covers 76 that are on the upstream end 41A side. In addition, in a case where the secondary transfer roll 34 is separated from the one end portion 70, the covers 74 bear a pressing force caused by the secondary transfer roll 34. Therefore, deterioration of the one end portion 70 and the other end portion 72 of the transfer jacket 44 is suppressed in comparison with the configuration in the present exemplary embodiment.

### Modification Examples

In the image forming apparatus 10 according to the present exemplary embodiment, the shapes of the one end portion 70 and the other end portion 72 of the transfer jacket 44 are triangular shapes that are the same as each other. However, the present disclosure is not limited thereto. The shapes of the one end portion 70 and the other end portion 72 may be triangular shapes different from each other. Specifically, the shape of the one end portion 70 may be a right-angled isosceles triangle, and the shape of the other end portion 72 may be an obtuse-angled isosceles triangle. It is preferable that each of these shapes is set based on, for example, an image formation region. In this case, a load fluctuation is suppressed in accordance with the shapes of the one end portion 70 and the other end portion 72 in comparison with a configuration in which the shapes of both end portions of the transfer jacket 44 are the same as each other. In addition, a triangular shape may be formed at any one of the one end portion 70 or the other end portion 72. Furthermore, the shapes of the one end portion 70 and the other end portion 72 are not limited to a shape that linearly extends toward the reference line M from both side ends and may be an arc shape or a wavy shape.

Hereinafter, modification examples of the one end portion 70 of the transfer jacket 44 will be described and the modification examples can also be applied to the other end portion 72. As shown in a part (a) in FIG. 8, a surface that extends toward the reference line M from the side end portion 70A and a surface that extends toward the reference line M from the side end portion 70B are formed at the one end portion 70 of the transfer jacket 44, the present disclosure is not limited thereto. For example, the one end portion 70 may have an asymmetric triangular shape. As shown in a part (b) in FIG. 8, a surface that extends from the reference line M toward the side end portion 70A and a surface that extends from the reference line M toward the side end portion 70B may be formed at the one end portion 70 of the transfer jacket 44. In this case, the base L in the above-described present exemplary embodiment corresponds to the sum of a line segment L1 and a line segment L2. The lengths of the line segment L1 and the line segment L2 are the same as each other and the sum of the line segment L1 and the line segment L2 is the length of contact. In addition, as shown in a part (c) in FIG. 8, the one end portions 70 of the transfer jacket 44 may be provided at both side ends (70A and 70B) in addition to a position on the reference line M so that the one end portions 70 are formed in a W-like shape (a triangular wave shape) as a whole in a top view. In this case, for example, an end portion 70E may be provided between the side end portion 70A and the reference line M in the depth direction (a right-left direction in the drawing) and an end portion 70D may be provided between the side end portion 70B and the reference line M in the depth direction with the end portion 70E and the end portion 70D being provided to be symmetrical with respect to the reference line M. Note that in this case, the base L in the above-described present exemplary embodiment corresponds to the sum of the line segment L1, the line segment L2, and a line segment L3. In addition, the entire one end portion 70 may have a shape like a sine wave as seen in a top view. In addition, although the one end portion 70 of the transfer jacket 44 is triangular, the one end portion 70 may have a trapezoidal shape as shown in a part (d) in FIG. 8. That is, edges of the one end portion 70 and the other end portion 72 of the transfer jacket 44 may not be entirely parallel to the axis of the secondary transfer roll 34 in the depth direction and the edges may be partially parallel to the axis. Specifically, in a case where a portion of the edge in the depth direction is parallel to the axis and the other portion of the edge is not parallel to the axis, the edge forms a trapezoidal shape, for example and in a case where the edge is not parallel to the axis throughout the depth direction, the edge forms a right-angled triangular shape (one-sided inclination) of which the hypotenuses is the entire edge, for example.

The transfer jacket 44 includes a base layer, an elastic layer, and a surface layer (which are not shown) in order of increasing distance to the cylindrical surface 42A and has a determined thickness in a state of being wound around the cylindrical surface 42A of the cylinder body 42. However, the present disclosure is not limited thereto. For example, the one end portion 70 or the other end portion 72 may be formed in a tapered shape of which the thickness decreases toward the recess portion 41 in a state where the transfer jacket 44 is wound around the cylindrical surface 42A of the cylinder body 42.

The present disclosure is not limited to the above-described exemplary embodiments, and various modifications, changes, and improvements can be made within a range without deviating from the gist of the present disclosure. For example, a plurality of the modification examples described above may be appropriately combined with each other and the transfer jacket 44 may have a shape asymmetric with respect to the reference line M and the transfer jacket 44 may be unreplaceable with respect to the cylinder body 42.

### Supplementary Note

(((1)))

A transfer device comprising:

a transfer member that is formed in an endless band-like shape and to which a toner image is transferred;

a transfer cylinder that includes a cylinder body having an outer peripheral surface at which a recess portion extending in an axial direction is formed and a transfer jacket that is wound around the outer peripheral surface such that both end portions of the transfer jacket are disposed outside the recess portion; and

a transfer roll that extends in the axial direction, that transfers the toner image to a recording medium wound around the transfer cylinder while sandwiching the transfer member together with the transfer jacket, and that repeats collision and separation with respect to the transfer jacket as the transfer roll passes through the recess portion,

wherein at least one end portion out of both end portions of the transfer jacket includes an edge that is not parallel to an axis of the transfer roll.

(((2)))

The transfer device according to (((1))),

wherein the transfer jacket is formed to be symmetrical with respect to a center in the axial direction.

(((3)))

The transfer device according to (((2))),

wherein the one end portion of the transfer jacket extends to become closer to the center from both side ends in the axial direction toward the recess portion and has a triangular shape.

(((4)))

The transfer device according to any one of (((1))) to (((3))),

wherein both end portions of the transfer jacket include edges that are not parallel to the axis of the transfer roll.

(((5)))

The transfer device according to any one of (((1))) to (((4))), wherein shapes of both end portions of the transfer jacket are different from each other.

(((6)))

The transfer device according to any one of (((1))) to (((5)))

wherein the transfer jacket is attached to the cylinder body such that the transfer jacket is replaceable.

(((7)))

The transfer device according to any one of (((1))) to (((6))), further comprising:

a covering portion that covers a portion between the at least one end portion out of both end portions of the transfer jacket and the recess portion and of which an elastic modulus is lower than an elastic modulus of the one end portion of the transfer jacket.

(((8)))

An image forming apparatus comprising:

an image forming unit that includes an image formation unit that forms the toner image and the transfer device according to any one of (((1))) to (((7))); and

a fixing device that fixes an image which is transferred to a recording medium by the image forming unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transfer device comprising:
a transfer member that is formed in an endless band-like shape and to which a toner image is transferred;
a transfer cylinder that includes a cylinder body having an outer peripheral surface at which a recess portion extending in an axial direction is formed and a transfer jacket that is wound around the outer peripheral surface such that both end portions of the transfer jacket are disposed outside the recess portion; and
a transfer roll that extends in the axial direction, that transfers the toner image to a recording medium wound around the transfer cylinder while sandwiching the transfer member together with the transfer jacket, and that repeats collision and separation with respect to the transfer jacket as the transfer roll passes through the recess portion,
wherein at least one end portion out of both end portions of the transfer jacket includes an edge that is not parallel to an axis of the transfer roll.

2. The transfer device according to claim 1,
wherein the transfer jacket is formed to be symmetrical with respect to a center in the axial direction.

3. The transfer device according to claim 2,
wherein the one end portion of the transfer jacket extends to become closer to the center from both side ends in the axial direction toward the recess portion and has a triangular shape.

4. The transfer device according to claim 1,
wherein both end portions of the transfer jacket include edges that are not parallel to the axis of the transfer roll.

5. The transfer device according to claim 4,
wherein shapes of both end portions of the transfer jacket are different from each other.

6. The transfer device according to claim 1,
wherein the transfer jacket is attached to the cylinder body such that the transfer jacket is replaceable.

7. The transfer device according to claim 1, further comprising:
a covering portion that covers a portion between the at least one end portion out of both end portions of the transfer jacket and the recess portion and of which an elastic modulus is lower than an elastic modulus of the one end portion of the transfer jacket.

8. An image forming apparatus comprising:
an image forming unit that includes an image formation unit that forms the toner image and the transfer device according to claim 1; and
a fixing device that fixes an image which is transferred to a recording medium by the image forming unit.

9. An image forming apparatus comprising:
an image forming unit that includes an image formation unit that forms the toner image and the transfer device according to claim 2; and
a fixing device that fixes an image which is transferred to a recording medium by the image forming unit.

10. An image forming apparatus comprising:
an image forming unit that includes an image formation unit that forms the toner image and the transfer device according to claim 3; and
a fixing device that fixes an image which is transferred to a recording medium by the image forming unit.

11. An image forming apparatus comprising:
an image forming unit that includes an image formation unit that forms the toner image and the transfer device according to claim 4; and
a fixing device that fixes an image which is transferred to a recording medium by the image forming unit.

12. An image forming apparatus comprising:
an image forming unit that includes an image formation unit that forms the toner image and the transfer device according to claim 5; and
a fixing device that fixes an image which is transferred to a recording medium by the image forming unit.

13. An image forming apparatus comprising:
an image forming unit that includes an image formation unit that forms the toner image and the transfer device according to claim 6; and
a fixing device that fixes an image which is transferred to a recording medium by the image forming unit.

14. An image forming apparatus comprising:
an image forming unit that includes an image formation unit that forms the toner image and the transfer device according to claim 7; and
a fixing device that fixes an image which is transferred to a recording medium by the image forming unit.
